(19) United States
(12) Patent Application Publication
(10) Pub. No.: US 2026/0256170 A1
(43) Pub. Date: Sep. 3, 2026

(54) BEVERAGE DEGASSING ASSEMBLY AND METHOD OF DEGASSING A BEVERAGE

(71) Applicant: Mayborn (UK) Limited, Newcastle Upon Tyne (GB)

(72) Inventors: Robert Kenneth Alexander Jervis, Newcastle Upon Tyne (GB); Liam George Clark, Newcastle Upon Tyne (GB)

(21) Appl. No.: 18/873,443

(22) PCT Filed: Jun. 9, 2023
(86) PCT No.: PCT/GB2023/051509

§ 371 Date: Dec. 10, 2024

(30) Foreign Application Priority Data
Jun. 10, 2022 (GB) 2208543.5

(51) Int. Cl. A23L 2/76; A23L 33/00; A61J 9/00; B01D 19/00

(52) U.S. Cl. CPC A23L 2/76; A23L 33/40; B01D 19/0036; A61J 9/00

(57) ABSTRACT

The present invention relates to a beverage degassing assembly, particularly an assembly for degassing a beverage held in a receptacle, for example an infant feeding bottle. The beverage degassing assembly comprises: a first assembly portion comprising a chamber and an opening to the chamber, wherein the chamber is configured to receive a receptacle for holding a beverage; a second assembly portion configured to be mountable to the first assembly portion so that the opening is selectively closed by the second assembly portion; and a pump assembly configured to be fluidly connected to the chamber when the second assembly portion is mounted to the first assembly portion. The pump assembly is configured, in use, to extract air from the chamber to provide a predetermined vacuum pressure in the chamber. A method of degassing a beverage is also disclosed.

The present invention relates to a beverage degassing assembly, particularly an assembly for degassing a beverage held in a receptacle, for example an infant feeding bottle. A method of degassing a beverage is also disclosed.

### INTRODUCTION

Conventional infant feeding bottle assemblies are used to feed infants, particularly to feed infants beverages such as infant formula milk or expressed breast milk. The assemblies include an infant feeding bottle as a receptacle for the beverage, as well as a nipple mounted and secured to the infant feeding bottle by a screw-on collar or screw ring.

A problem with conventional feeding bottles is that they may allow ingestion of air as the infant feeds from the nipple. In particular, the beverage within the infant feeding bottle assembly may contain air associated therewith that is consumed with the beverage. Ingestion of air, potentially leading to a build-up of air in an infant's stomach, is thought to be a contributing factor to colic.

Typically, infant feeding bottle assemblies are used by preparing a beverage in the infant feeding bottle and then attaching the nipple to the container using the screw ring, ready for feeding. Preparing infant formula milk requires agitating, typically by shaking, of the infant feeding bottle assembly to disperse and dissolve infant formula powder in cooled boiled water. Vigorous agitation is required because incorrect or inadequate dispersion of infant formula powder results in solids or lumps of particles in the milk which can block the nipple outlet, causing frustration for the feeding infant. Alternatively, premade infant formula milk and expressed milk may be used by pouring into the infant feeding bottle prior to attaching the nipple.

A common feature of infant feeding bottle assemblies is a venting system to alleviate negative pressure which would otherwise build up within the container as infant sucks a beverage from the nipple. In certain known arrangements, an air vent is mounted within the nipple or screw ring to vent air from the atmosphere into the infant feeding bottle assembly to prevent vacuum pressure build up as the beverage is removed from the bottle. Due to the arrangement of the vent in the nipple or screw ring, the vented air bubbles through the beverage as it is fed to the infant. This increases the volume of air associated with the beverage.

Certain known arrangements attempt to relieve or avoid bubbling air through the beverage by using a venting system including an air conduit communicating with the atmosphere through an inlet. Typically, the air conduit is formed within an insert, or body, of a member which is mounted to the mouth of the infant feeding bottle. A further conduit, for example a tube or tube portion, projects down from the air conduit to a location close to the bottom of the infant feeding bottle. When the infant is feeding the infant feeding bottle assembly is inverted so that an end of the tube portion projects above the meniscus of the liquid. An air passage for pressure equalisation is thereby provided from the atmosphere through the tube and air conduit to the head space above the beverage in the infant feeding bottle as the infant drinks.

One of the drawbacks of the solutions according to the prior art is that they do not address the air associated with the liquid before feeding begins. Agitating formula infant formula powder in water, or pouring a beverage into the infant feeding bottle mixes air with the beverage. Thus, air associated with the beverage prior to feeding remains held within the beverage as it is consumed.

Accordingly, it would be useful to prepare a beverage in a convenient manner. It would be useful to prepare a beverage in a manner which is compatible with a range of receptacles used for consuming the beverage.

It would also be useful to reduce or remove the amount of air ingested when consuming a beverage. In particular, it would be useful to alleviate or reduce the amount air which is, or which may be, concomitantly ingested by an infant when consuming a beverage from an infant feeding assembly.

### SUMMARY OF THE INVENTION

The invention is set out in the appended claims.

According to an aspect of the invention, there is provided a beverage degassing assembly including:
a first assembly portion including a chamber and an opening to the chamber, wherein the chamber is configured to receive a receptacle for holding a beverage;
a second assembly portion configured to be mountable to the first assembly portion so that the opening is selectively closed by the second assembly portion; and
a pump assembly configured to be fluidly connected to the chamber when the second assembly portion is mounted to the first assembly portion;
wherein the pump assembly is configured, in use, to extract air from the chamber to provide a predetermined vacuum pressure in the chamber.

Aptly, the predetermined vacuum pressure may be in the range from 40 kPa to 60 kPa, preferably in the range from 45 kPa to 55 kPa. As used herein the vacuum pressure is an absolute air pressure. The vacuum pressure is an absolute air pressure relative to an ambient atmospheric air pressure of around 100 kPa.

Aptly, the pump assembly may be configured to extract air from the chamber so as to provide the predetermined vacuum pressure in the chamber in pressurising time period. The pressurising time period may be in the range of from 10 seconds to 120 seconds, preferably in the range of from 20 seconds to 60 seconds.

Aptly, the pump assembly may configured to actuate a pressure alarm signal when the pressurising time period exceeds a predetermined pressurising time period. The predetermined pressurising time period may be any one of 30 seconds, 40 seconds, 50 seconds, or 60 seconds.

Aptly, the pressure alarm signal may one or more of an audible pressure alarm signal, a visual pressure alarm signal or a vibrational pressure alarm signal. The visual pressure alarm signal may correspond to an indicator light wherein the indicator light emits a light, a flashing light, or a change of light colour.

Aptly, the pump assembly may include a detector for determining a vacuum pressure generated by extracting air from the chamber.

Aptly, the predetermined vacuum pressure may be selectively adjustable.

Aptly, the pump assembly may maintain the predetermined vacuum pressure for a predetermined time period.

Aptly, the time period may be in the range from 1 minute to 5 minutes, preferably from 1.5 minutes to 3 minutes.

Aptly, the time period may be selectively adjustable.

Aptly, the pump assembly may be mounted within the second assembly portion.

Aptly, the assembly may further include a vacuum release port fluidly coupled to an ambient atmosphere, wherein the vacuum release port is configured to be actuatable so as to selectively vent air into the chamber from the ambient atmosphere. The vacuum release port may be manually actuatable by a user. For example, a user may manually actuate the vacuum release port by depressing a button.

Aptly, the first assembly portion and the second assembly portion may include mutually disposed inter-engagement means.

Aptly, the beverage degassing assembly may further include a detector configured to determine a tilt angle of a central longitudinal axis of the first assembly portion relative to a vertical axis.

Aptly, the detector may be configured to actuate an alarm signal when the tilt angle is greater than 30° relative to the vertical axis and, more aptly, to actuate an alarm signal when the tilt angle is greater than 45° relative to the vertical axis. Aptly, the detector may be configured to actuate an alarm signal when the tilt angle is in the range from 30° to 180° relative to the vertical axis and, more aptly, to actuate an alarm signal when the tilt angle is in the range from 45° to 180° relative to the vertical axis.

Aptly, the alarm signal may one or more of an audible alarm signal, a visual alarm signal or a vibrational alarm signal. The visual alarm signal may correspond to an indicator light wherein the indicator light emits a light, a flashing light, or a change of light colour.

Aptly, the chamber may be configured to receive a receptacle which is a receptacle of an infant feeding bottle assembly, an infant drinking cup assembly, or a breast pump assembly.

Aptly, the first assembly portion may include a glass material, typically the container is formed from a glass material. The first assembly portion, typically the container, is dimensioned such that the container is able to withstand negative pressures used in the beverage degassing assembly.

Aptly, the first assembly portion and/or the second assembly portion may be formed of a polymer material. In particular, the first assembly portion and the second assembly portion may be formed of materials that are suitable to withstand negative pressures used in the beverage degassing assembly. The first assembly portion and the second assembly portion may be formed of different materials.

Aptly, the polymer material may a thermoplastic polymer material. The polymer material may be a polycarbonate material, a polypropylene material, an acrylonitrile butadiene styrene material (ABS), or a styrene acrylonitrile material (SAN). In particular, suitable polymer materials provide a transparency to allow the user to see the receptacle received within the chamber during use.

According to another aspect of the invention, there is provided beverage degassing assembly including:
a first assembly portion including a chamber and an opening to the chamber, wherein the chamber is configured to receive a receptacle for holding a beverage;
a second assembly portion including a pump assembly, wherein the second assembly portion is configured to be mountable to the first assembly in a first position; and
wherein, in the first position, the opening is selectively closed by the second assembly portion and the pump assembly is fluidly connected to the chamber to operably extract air from the chamber.

Aptly, the pump assembly may be configured to extract air from the chamber to provide a predetermined vacuum pressure in the chamber

According to a further aspect of the invention, there is provided method of degassing a beverage, the method including:
loading a receptacle containing a beverage into a chamber of a first assembly portion, wherein the receptacle is loaded through an opening of the chamber;
mounting a second assembly portion to the first assembly to close the opening;
fluidly connecting a pump assembly to the chamber; and
using the pump assembly to extract air from the chamber to provide a predetermined vacuum pressure in the chamber.

Aptly, the pump assembly may provide the predetermined vacuum pressure for a predetermined time period.

Aptly, the step of using the pump assembly to extract air from the chamber to provide a predetermined vacuum pressure may require a pump operating time period in the range of from 10 seconds to 120 seconds, preferably in the range of from 20 seconds to 60 seconds.

Aptly, the pump assembly may be mounted in the first assembly portion or in the second assembly portion.

Aptly, the method may further include a step of selectively venting air into the chamber, wherein the air is vented into the chamber using an actuatable vacuum release port fluidly coupled to an ambient atmosphere.

Certain examples provide an apparatus or provide a method for improving the quality of a beverage. Certain examples provide an apparatus or method that reduces the air associated with a beverage. Particularly, dissolved air may be reduced prior to ingesting the beverage. Consequently, a potential risk of colic from build-up of air in an infant's stomach is reduced.

Certain examples provide a reduction in air associated with a beverage in convenient manner. The reduction in air is provided immediately prior to consumption. The reduction in air is also provided in the receptacle from which the beverage is consumed, thereby eliminating the risk of mixing air into the beverage by, for example, transferring the beverage into a receptacle for drinking.

Certain examples alleviate or reduce the volume air mixed with the beverage during preparation of the beverage. In particular, air introduced by vigorous agitation of infant formula powder can be alleviated. In this way, the infant formula powder can be reliably and adequately dispersed in water without the risk solids causing blockage of the nipple.

Certain examples provide a reduction in air associated with a beverage without risk of damage to the receptacle. In particular, a vacuum pressure is applied to a beverage without applying a pressure difference between the interior and exterior of the receptacle.

Certain examples enable the user to adjust the vacuum pressure conditions according to the beverage in the receptacle. In this way, the magnitude of the vacuum pressure in the chamber, as well as the duration for which it is applied to the chamber, can be selectively adjusted.

Certain examples enable a convenient release of a vacuum pressure within the chamber.

### BRIEF DESCRIPTION OF THE DRAWINGS

Embodiments of the invention are now described, by way of example only, hereinafter with reference to the accompanying drawings, in which:

FIG. 1 shows a perspective view of an example beverage degassing assembly and beverage receptacle;

FIG. 2 shows a perspective view of the example of FIG. 1 with the second assembly portion dismounted from the first assembly portion;

FIG. 3 shows (a) an upper perspective view and (b) a lower perspective view of the second assembly portion of the example of FIG. 1;

FIG. 4 shows cross-sectional perspective views of (a) the second assembly portion taken through plane X-X of FIG. 3, and (b) a magnified portion of the same; and

FIG. 5 shows a perspective view of another example beverage degassing assembly holding an alternative beverage receptacle assembly.

In the drawings, like reference numerals refer to like parts.

### DETAILED DESCRIPTION

Certain terminology is used in the following description for convenience only and is not limiting. The words ‘lower’, ‘upper’, ‘front’, ‘rear’, ‘upward’, ‘down’ and ‘downward’ designate directions in the drawings to which reference is made and are with respect to the described component when assembled and mounted. The words ‘inner’ and ‘outer’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’, ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, ‘first’, ‘second’, ‘third’ etc. merely indicate that different instances of like objects are being referred to and are not intended to imply that the objects so described must be in a given sequence, either temporally, spatially, in ranking or in any other manner.

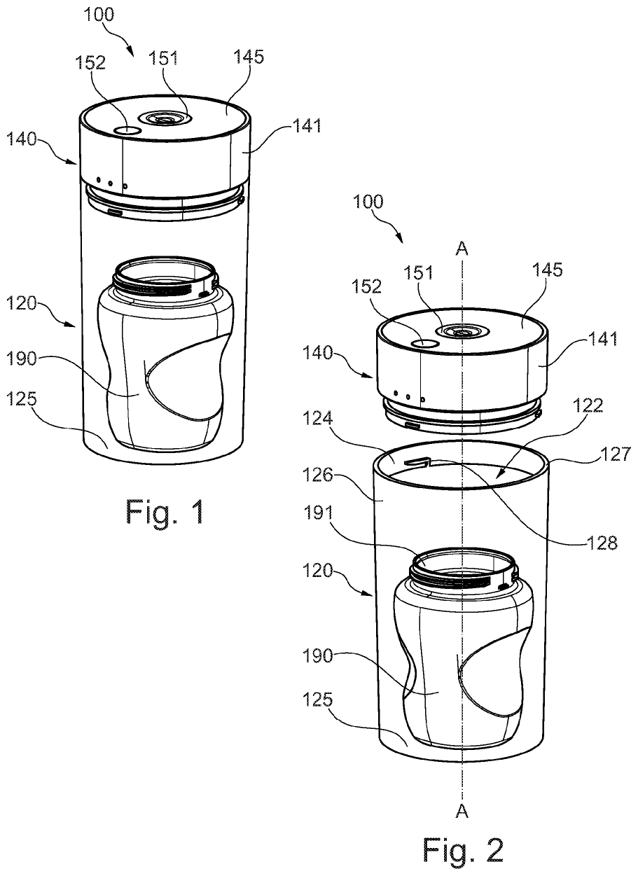

Referring now to FIGS. 1 and 2, there is shown a beverage degassing assembly 100 including a first assembly portion 120 with a chamber 122 and an opening 124 to the chamber 122. The chamber 122 is configured to receive a receptacle for holding a beverage. In the example shown, the receptacle is an infant feeding bottle 190. The beverage degassing assembly 100 also includes a second assembly portion 140 configured to be mountable to the first assembly portion 120 so that the opening 124 is selectively closed by the second assembly portion 140. A pump assembly is configured to be fluidly connected to the chamber 122 when the second assembly portion 140 is mounted to the first assembly portion 120 and further configured, in use, the extract air from the chamber 122 to provide a predetermined vacuum pressure in the chamber 122.

As shown in FIG. 1, the second assembly portion 140 may be mounted to the first assembly portion 120 to selectively close the opening 124 to the chamber 122. As shown in FIG. 2, the second assembly portion 140 may be dismounted from the first assembly portion 120 to selectively open the opening 124 to the chamber 122 in readiness to receive an infant feeding bottle 190.

The first assembly portion 120 is in essence a cup-like container that is sized sufficiently to receive a receptacle. The assembly portion 120 includes a chamber 122 suitable for receiving a receptacle holding a beverage. Typically, the receptacle is a receptacle for holding sufficient beverage to provide a single feed portion of the beverage. In the example shown, the receptacle is a feeding bottle 190 of an infant feeding bottle assembly with capacity to hold a single feed of beverage, such as infant formula milk.

The chamber 122 and the opening 124 are each configured to receive receptacles of a range of sizes without a significant residual volume surrounding the receptacle. Thus, the volume of the first assembly portion 120 may be optimised so that it can be used to apply a vacuum pressure to a range of receptacles in a space efficient way. A vacuum pressure may be applied by pumping a reduced volume of air from the chamber 122.

The first assembly portion 120 includes an opening 124 for receiving a receptacle as it is loaded into the chamber 122. In the example shown, the opening 124 is sized and oriented to allow an infant feeding bottle 190 to be loaded into the chamber 122 in a vertical orientation. In this way, an open top 191 of the infant feeding bottle 190 faces towards the opening 124 when received in the chamber 122.

The chamber 122 is an annular chamber. The first assembly portion 120 includes a central longitudinal axis A. The central longitudinal axis A extends from a base 125 of the chamber 122 to the opening 124. With the first assembly portion 120 is disposed on a horizontal support surface the central longitudinal axis A extends perpendicular therefrom. That is, with the first assembly portion 120 disposed on a horizontal support surface the central longitudinal axis A is oriented vertically.

The opening 124 of the chamber of the first assembly portion 120 is surrounded by a first annular wall 126. The first annular wall 126 extends upwards from a wall enclosing the chamber 122. The first annular wall 126 is configured to provide sealing engagement of the first assembly portion 120 with the second assembly portion 140. The first annular wall 126 includes an upper rim 127 for sealingly engaging with the second assembly portion 140, as described herein.

The first annular wall 126 includes a first engagement means. In the example shown in FIG. 2, the first engagement means is a pair of projections 128 on the first annular wall 126. The projections 128 are circumferential projections, opposingly disposed on the inner surface of the first annular wall 126. Each projection of the pair of projections 128 is arranged to rotatably engage with corresponding second engagement means provided on the second assembly portion 140.

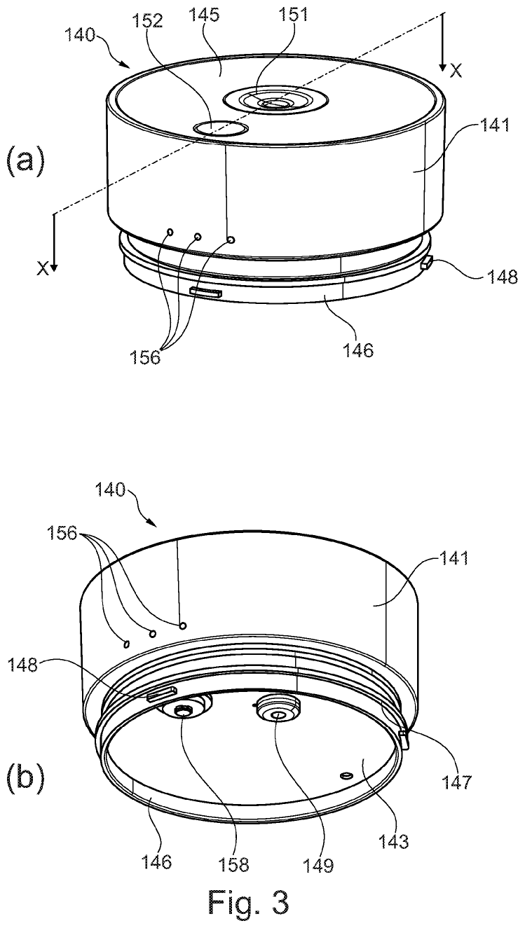

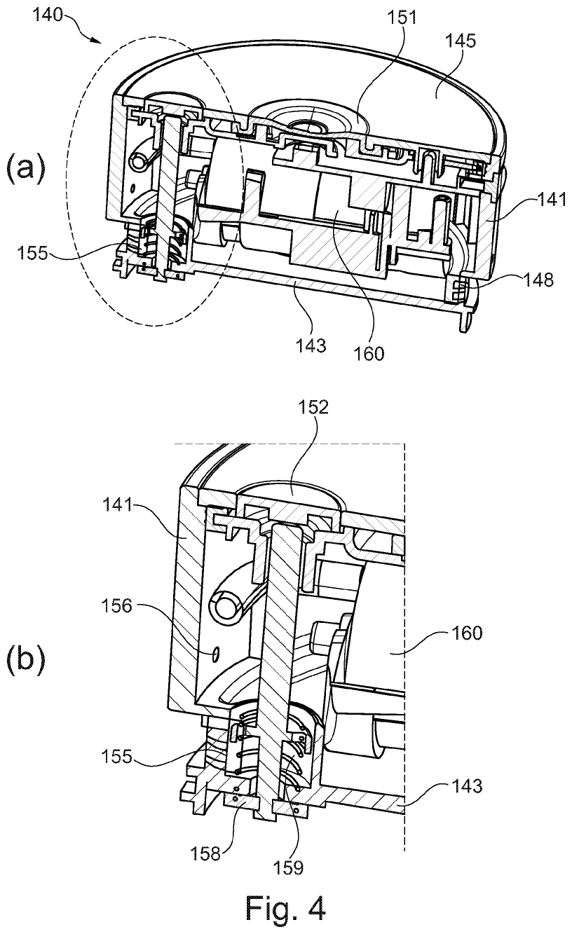

The second assembly portion 140 is in essence a lid to the first assembly portion. It includes an annular body 141 with a base 143 and a cover 145. The annular body 141 encloses a volume sized to contain the pump assembly as described below. Referring additionally to FIGS. 3 and 4, there is shown further details of the second assembly portion 140 described with reference to FIGS. 1 and 2.

The pump assembly is provided in the second assembly portion 140. The pump assembly is mounted within the annular body 141 of the second assembly portion 140 so as to be fluidly connected to the chamber 122 when the opening 124 of the first assembly portion 120 is selectively closed by the second assembly portion 140. The pump assembly includes an electromechanical pump 160 for extracting air, and an inlet conduit extending from the electromechanical pump 160 to an inlet port 149 provided through the base 143 of the annular body 141. Thus, when the pump assembly is activated, air is extracted from the chamber by the electromechanical pump 160 through the inlet port 149 and inlet conduit.

The pump assembly further includes an outlet conduit extending from the electromechanical pump 160 to an outlet port. The outlet port fluidly connects the outlet conduit to an ambient atmosphere, typically the ambient atmosphere external to the second assembly portion 140. Typically, the outlet port is provided through the annular body 141.

The pump assembly includes a first actuator 151. The first actuator 151 is provided on the cover 145 of the second assembly portion 140. The first actuator 151 is configured to selectively activate the pump assembly mounted within the second assembly portion 140. The pump assembly is configured, when activated by the first actuator 151, to extract air from the chamber 122 of the first assembly portion 120 as described in herein.

The beverage degassing assembly 100 includes a vacuum release port 155 fluidly coupled to an ambient atmosphere. In the example shown, the vacuum release port 155 is fluidly coupled to the ambient atmosphere external to the annular body 141 by plurality of orifices 156 extending through the annular body 141.

As shown particular with reference to FIG. 4, the vacuum release port 155 is mounted through the base 143 of the annular body 141. The vacuum release port 155 includes a resiliently deformable plug 158 to seal the vacuum release port 155. The deformable plug 158 is movable between a first, closed position and a second, open position. In the second position a fluid flow path is provided from the ambient atmosphere through the vacuum release port 155. In the first position, the fluid flow path is closed.

The deformable plug 158 is biased in the closed position. The deformable plug 158 is biased in the closed position by a spring member 159. The spring member 159 is disposed in a partially compressed state between the upper surface of the base 143 and a receiving flange operably connected to the second actuator 152. In this way, in the first position, the spring member 159 biases the deformable plug 158 against the lower surface of the base 143. The spring member 159 biases the deformable plug to close the vacuum release port 155. Actuation of the second actuator 152 further compresses the spring member 159 thereby overcoming the bias provided by the spring member 159 and moving the deformable plug 158 away from the lower surface of the base 143 to the second position. Actuating the second actuator 152 to overcome the bias of the spring member 159 opens the vacuum release port 155.

In this way, when the second assembly portion 140 is mounted on the first assembly portion 120, with the vacuum release port 155 in the second position a fluid flow path is provided from the ambient atmosphere to the chamber 122. The vacuum release port 155 selectively opens a fluid flow path between the chamber 122 and the ambient atmosphere.

The cover 145 includes a second actuator 152 arranged to selectively actuate the vacuum release port 155. The second actuator 152 selectively actuates the vacuum release port 155 to move the deformable plug 158 to the second position. The second actuator 152 selectively actuates the vacuum release port 155 to selectively open a fluid flow path between the chamber 122 and the ambient atmosphere.

The second assembly portion 140 is configured to be mountable to the first assembly portion 120 to selectively close the opening 124 of the first assembly portion 120. The second assembly portion 140 includes a second annular wall 146 depending from the base 143 of the second assembly portion 140. The second annular wall 146 is configured to be received within the first annular wall 126 of the first assembly portion 120. The second annular wall 146 is telescopingly received within the first annular wall 126 and secured using suitable inter-engagement means, such as the examples described herein.

An annular sealing surface 147 is provided on second assembly portion 140. The annular sealing surface 147 is arranged to sealingly engage the upper rim 127 of first assembly portion 120.

The second annular wall 146 includes a second engagement means. In the example shown in FIG. 3, the second engagement means is a number of projections 148 on the second annular wall 146. The projections 148 are arranged circumferentially on the outer surface of the second annular wall 146. Each projection 148 is configured to be a portion of a screw thread to rotatably engage with the corresponding first engagement means provided on the first assembly portion 120.

The first engagement means and the second engagement means together provide mutually disposed inter-engagement means. That is, inter-engagement of the first engagement means with the second engagement means secures the first assembly portion 120 to the second assembly portion 140 with relative rotation between the first assembly portion 120 and second assembly portion 140. The inter-engagement means secure the first assembly portion 120 to the second assembly portion 140 so that the opening 124 of the chamber 122 is closed with an air-tight seal to the second assembly portion 140.

Optionally, the annular sealing surface 147 includes an elastomer. The elastomer may be formed on the annular sealing surface 147 or may be provided as a separate component, for example an elastomeric ring. In the example, the elastomer is a silicone rubber. In these ways, the annular sealing surface 147 may be resiliently compressed as the second assembly portion 140 is mounted to the first assembly portion 120. The opening of the chamber is thereby closed with a more reliable air-tight seal. That is, the air-tight seal is able to withstand increased vacuum pressure within the chamber 122.

The first assembly portion 120 and the second assembly portion 140 are formed of suitably rigid materials to withstand negative pressures used in the beverage degassing assembly 100. In the example, the second assembly portion 140 is formed of a styrene acrylonitrile material (SAN).

The beverage degassing assembly 100 further includes a detector configured to determine a tilt angle of the central longitudinal axis A of the first assembly portion 120 relative to a vertical axis. The detector is mounted within the second assembly portion 140 so as to determine a tilt angle of the central longitudinal axis A when the second assembly portion 140 is mounted to the first assembly portion 120. In this way, the detector is able to actuate an alarm signal if, during use, the beverage degassing assembly 100 is titled at angle. The alarm signal provides a warning to the user that the beverage may spill from the receptacle disposed therein.

In the example shown, the detector is configured to actuate an alarm signal when the tilt angle is greater than 30° relative to the vertical axis.

In the example shown in FIGS. 1 to 4, the detector is operably connected to a light mounted in the annular body 141. In this way, to actuate an alarm signal the detector illuminates the light in the annular body 141. The detector provides a visual alarm signal to the user.

The detector is selectively activated when the beverage degassing assembly 100 is used to extract air from the chamber 122. In this way, the detector does not provide an alarm signal until the user mounts the second assembly portion 140 to the first assembly portion 120 and actuates the beverage degassing assembly 100 to extract air.

The detector is deactivated after the beverage degassing assembly 100 ceases extracting air. In particular, the detector is deactivated after the beverage degassing assembly 100 ceases extracting and the vacuum pressure in the chamber 122 is released.

To use the example degassing assembly 100, an infant feeding bottle 190 holding a beverage is loaded into the first assembly portion 120. The first assembly portion 120 receives the infant feeding bottle 190 through the opening 124 of the chamber 122. The second assembly portion 140 is then mounted to the first assembly portion 120 in a mounted position so as to selectively close opening 124. The infant feeding bottle 190 is disposed within the chamber 122 with the second assembly portion 140 providing an air-tight closure of the opening 124. The infant feeding bottle 190 is thus isolated within the chamber 122.

With the second assembly portion 140 in the mounted position the pump assembly of the second assembly portion 140 is fluidly connected to the chamber 122 of the first assembly portion 120 via the inlet port 147 and inlet conduit 161. In this way, the pump assembly is operable to extract air from the chamber 122.

In the example shown, the pump assembly is configured to extract air to provide a predetermined vacuum pressure in the chamber 122. The pump assembly includes an air pressure detector. The air pressure detector continuously monitors the vacuum pressure in the chamber 122 by measuring the vacuum pressure in the inlet conduit. The air pressure detector thereby determines the vacuum pressure upstream of the pump assembly as air is extracted from the chamber 122.

Actuation of the first actuator 151 activates the pump assembly to extract air from the chamber 122 of the first assembly portion 120. Upon actuation, the pump assembly extracts air from the chamber 122 until a vacuum pressure of 50 kPa is measured by the air pressure detector. That is, air is removed from the chamber 122 so that the air pressure within the chamber 122 is reduced from an ambient atmospheric pressure, typically around 100 kPa, to 50 kPa.

When the predetermined vacuum pressure is attained, the pump assembly continues to extract air from the chamber 120 at a rate sufficient to maintain the 50 kPa vacuum pressure in the chamber 120 for a predetermined time period. In the example shown, the vacuum pressure is maintained for 2 minutes. That is, once the vacuum pressure in the chamber 122 reaches 50 kPa, the pump assembly continues to extract sufficient air so that a vacuum pressure of 50 kPa is maintained within the chamber 122 for a further 2 minutes.

Advantageously, by providing a vacuum pressure in a chamber 122 holding the receptacle, the receptacle is not subjected to a pressure difference between its interior and exterior. Thus, the beverage held by the receptacle, in the example an infant feeding bottle 190, is subjected to a vacuum pressure without distortion of the receptacle caused by a pressure difference across the receptacle wall. The beverage is subjected to a vacuum pressure without risking damage to the receptacle.

After maintaining a vacuum pressure for a duration of 2 minutes, the pump assembly is deactivated. The pump assembly thereby ceases to extract further air from the chamber 122.

With the pump assembly deactivated the vacuum pressure within the chamber 122 is released.

Optionally, the vacuum pressure may be gradually released, for example by air leaking slowly through the pump assembly from the ambient atmosphere. Nevertheless, depending on the configuration of the pump assembly and the electromechanical pump 160 therein, the vacuum pressure may be retained for several minutes or more.

Alternatively, the vacuum pressure in the chamber 122 may be selectively released. In the example shown the vacuum pressure is selectively release by actuation of the vacuum release port 155 using the second actuator 152. Actuating the vacuum release port 155 opens a fluid flow path between the chamber 122 and the ambient atmosphere. Actuating the vacuum release port 155, in this example by operating the second actuator 152, thereby vents air into the chamber 122 from the ambient atmosphere. Vacuum pressure in the chamber 122 is restored to ambient atmospheric pressure in a quick and convenient manner.

In the example shown in FIG. 1, the beverage degassing assembly 100 includes a first actuator 151 to selectively activate the pump assembly to extract air to reach a vacuum pressure of 50 kPa, and then maintain the vacuum pressure for a further 2 minutes. Optionally, the pump assembly may be adapted to provide a range of vacuum pressures in the chamber. Further optionally, the pump assembly may also be adapted to maintain a vacuum pressure in the chamber for a range of time periods. The time periods may be adapted in addition to, or as an alternative to, adapting the vacuum pressure. In this way, the operation of the pump assembly may be optimised according to the beverage in the receptacle so that an increased vacuum pressure and/or an increased duration may be applied when air is more tightly associated with the beverage.

The time periods and/or the vacuum pressure may be adjusted by any suitable interface or controller operably connected to the pump assembly. Thus, a user may be able to select or input a desired vacuum pressure to be applied to the chamber. A user may be able to select or input a desired time period for the duration of the vacuum pressure.

Input means, such as additional actuators, may be provided to on either the first assembly portion 120 or the second assembly portion 140 to enable user to adjust the pump assembly settings. In certain examples, a desired vacuum pressure to be applied to the chamber and/or a desired time period for the duration of the vacuum pressure may be transmitted to the pump assembly via a Bluetooth® or other wireless connection from a user's smartphone, tablet or computer. The user may be able to monitor the vacuum pressure and the duration of the vacuum pressure via a display of the measurement from the air pressure detector using a web page or an app.

The effectiveness of the example degassing assembly 100 in reducing gas associated with a beverage was examined using a dissolved oxygen test method. A commercially available dissolved oxygen meter, a Jenway 9500 Meter, was set up according to its operating instructions. The probe of the meter was calibrated and zeroed using the manufacturer's standard calibration process.

A first infant milk formula beverage was prepared using powdered infant formula and heated water in an infant feeding bottle of 260 ml capacity. Sufficient powdered formula and water were used to make 4 fluid ounces of formula beverage according to the powdered formula instructions. A lid was secured to the opening of the infant feeding bottle and the powdered formula dispersed within the water for ten seconds.

After dispersing, the probe of the dissolved oxygen meter was placed into the formula beverage to a depth of 60 ml in the infant feeding bottle, and a dissolved oxygen reading allowed to stabilise for 5 seconds. A ‘before’ dissolved oxygen reading of the mixed formula beverage was recorded as both (1) a percentage dissolved oxygen and (2) a concentration of milligrams of oxygen per litre of beverage (mg L⁻¹) compared to the calibrated probe.

Subsequently, the infant feeding bottle, including the formula beverage, was placed in the chamber 122 of the first assembly portion 120 of the example degassing assembly 100 of FIGS. 1 to 4. The second assembly portion 140 was mounted to the first assembly portion 120, closing the opening 124 of the first assembly portion 120, and the pump assembly was activated. Air was extracted from the chamber 122 to subject the infant feeding bottle and formula beverage to a vacuum pressure of 50 kPa for 2 minutes.

After releasing the vacuum and removing the second assembly portion 140, the probe of the dissolved oxygen meter was again placed into the formula beverage to a depth of 60 ml and the dissolved oxygen reading allowed to stabilise for 5 seconds. An ‘after’ dissolved oxygen reading of the degassed formula beverage was recorded as both (1) a percentage dissolved oxygen and (2) a concentration of oxygen (in mg L⁻¹) compared to the calibrated probe.

The test was repeated with a further nine infant formula samples to provide a single series of tests with average % reduction of dissolved oxygen and average mg L⁻¹ reduction of dissolved oxygen.

In a first series of tests and in a third series of tests, the powdered formula was dispersed by shaking the mixture within the infant feeding bottle.

In a second series and in a fourth series of tests, the powdered formula was dispersed by stirring the mixture within the infant feeding bottle.

During the first and second series of tests, the beverage degassing assembly, and thereby the formula beverage, was static.

During the third and fourth series of tests, the beverage degassing assembly was moved to continuously swirl the formula beverage once per second within the infant feeding bottle.

The average % reductions and average mg L⁻¹ reductions in dissolved oxygen for each test series is set out in Table 1.

TABLE 1

| | | | | | Concentration of | | |
|---|---|---|---|---|---|---|---|
| | | Dissolved oxygen/% | | | dissolved oxygen/mg L⁻¹ | | |
| | | Min | Max | Average | Min | Max | Average |
| Test | Before | 104 | 119 | 112 | 4.97 | 5.8 | 5.53 |
| Series 1 | After | 62 | 97 | 79 | 4.22 | 5.7 | 4.61 |
| Test | Before | 71 | 83 | 76.1 | 4.45 | 6.89 | 5.98 |
| Series 2 | After | 40 | 58 | 50.9 | 2.66 | 6.89 | 4.05 |
| Test | Before | 97 | 102 | 98.4 | 6.97 | 8.04 | 7.59 |
| Series 3 | After | 65 | 75 | 68.7 | 5.04 | 7.49 | 5.57 |
| Test | Before | 74 | 82 | 77.8 | 5.65 | 6.48 | 5.931 |
| Series 4 | After | 49 | 62 | 54.6 | 3.54 | 5.83 | 4.22 |

Thus, as an example, the average percentage of dissolved oxygen in test series 1, was reduced from 112% to 79% by the example degassing apparatus. As a further example the average concentration of dissolved oxygen in test series 2 was reduced from 5.98 mgL⁻¹ to 4.05 mgL⁻¹.

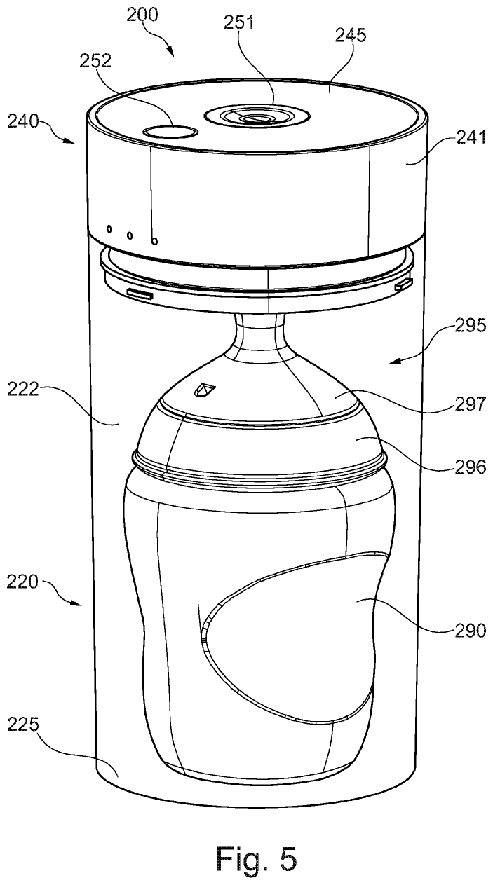

Referring now to FIG. 5, there is shown another example beverage degassing assembly. Where the features are the same as a previous example, the reference numbers are also the same, but with a “2” as the initial digit. Thus, there is shown a beverage degassing assembly 200 including a first assembly portion 220 with a chamber 222 and an opening 224 to the chamber 222. In contrast to the previous example, the chamber 222 is configured to receive a receptacle assembly including a receptacle for holding a beverage. In the example shown, the receptacle assembly is an infant feeding bottle assembly 295, including an infant feeding bottle 290 with a nipple 297 mounted to the bottle 290 with a screw collar 296. The nipple 297 includes an opening for egress of the beverage held therein during feeding.

The beverage degassing assembly 200 also includes a second assembly portion 240 configured to be mountable to the first assembly portion 220 so that the opening 224 is selectively closed by the second assembly portion 240. A pump assembly is configured to be fluidly connected to the chamber 222 when the second assembly portion 240 is mounted to the first assembly portion 220 and further configured, in use, the extract air from the chamber 222 to provide a predetermined vacuum pressure in the chamber 222.

The second assembly portion 240 includes an annular body 241 with a base 243 and a cover 245. The annular body 241 encloses a volume sized to contain the pump assembly substantially as described herein with respect to FIGS. 1 to 4.

The pump assembly includes a first actuator 251. The first actuator 251 is provided on the cover 245 of the second assembly portion 240 and configured to selectively activate the pump assembly mounted within the second assembly portion 240.

The cover 245 includes a second actuator 252 arranged to selectively actuate the vacuum release port to selectively open a fluid flow path between the chamber 222 and the ambient atmosphere.

The pump assembly is configured to be used in the same manner as the previous example. The first assembly portion 220 receives the infant feeding bottle assembly 295 through the opening 224 of the chamber 222. The second assembly portion 240 is then mounted to the first assembly portion 220 in a mounted position so as to selectively close the opening 224. The infant feeding bottle assembly 295 is disposed within the chamber 220 with nipple 297 oriented towards the opening 224 of the chamber 222. The second assembly portion 240 provides an air-tight closure of the opening 224. The infant feeding bottle assembly 295 is thus isolated within the chamber 222.

With the second assembly portion 240 in the mounted position the pump assembly of the second assembly portion 240 is fluidly connected to the chamber 222 of the first assembly portion 220 via the inlet port and inlet conduit. In this way, the pump assembly is operable to extract air from the chamber 222 and provide a vacuum pressure therein.

Furthermore, due to the opening in the nipple 297, air is extracted from the interior of the infant feeding bottle assembly 295, subjecting the beverage to a vacuum pressure in the same manner as the previous example.

In certain examples, the first assembly portion may be oriented or sized to receive a receptacle in other orientations. For example, the opening and chamber may be arranged so that the receptacle is received in a vertical orientation through a side opening of the chamber.

In certain examples, the first assembly wall and second assembly wall are described as annular walls which are provided in telescoping arrangement. However, any suitable arrangement may be used to mount a second assembly portion to a first assembly portion. Non-limiting examples of inter-engagement means may include screw threads, bayonet locks arrangements, or releasable clamping means.

In certain examples, the pump assembly may be mounted in the first assembly portion or the second assembly portion. For example, the pump assembly may be mounted in a volume provide below the base of the chamber of the first assembly portion. In this way, an inlet conduit for fluidly connecting the pump assembly to the chamber and an inlet port may be provided in the first assembly portion.

In certain examples, the pump assembly includes an electromechanical pump to extract air. However, any other suitable means for extracting air may be provided in the pump assembly, for example a manually actuated mechanical pump.

In certain examples, a vacuum release port is described mounted in second assembly portion. In an alternative arrangement, a vacuum release port may be mounted in the first assembly portion. For example, the first assembly portion may include an actuatable vacuum release port mounted in a base of the chamber.

In certain examples, the first actuator and the second actuator may be mounted in any suitable portion of the degassing assembly. Thus, if the pump assembly is mounted in the first assembly portion then a first actuator may also be provided therein. Independent to the location of the pump assembly, if a vacuum release port is provided in the first assembly portion then the second actuator may also be provided therein.

As will be appreciated, any of the example beverage degassing assemblies described herein may be provided with or without a detector for determining a tilt angle. The pump assembly may be configured to extract air either with or without a tilt angle detector.

Where a tilt angle detector is provided, it may be provided in the first assembly portion or provided in the second assembly portion. Yet further, the detector may be provided in the first assembly portion or provided in the second assembly portion independent of the location of the pump assembly. Where a tilt angle detector is provided, it may be selectively activated in conjunction with, or independent from activation of the pump assembly.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A beverage degassing assembly comprising:
a first assembly portion comprising a chamber and an opening to the chamber, wherein the chamber is configured to receive a receptacle for holding a beverage;
a second assembly portion configured to be mountable to the first assembly portion so that the opening is selectively closed by the second assembly portion; and
a pump assembly configured to be fluidly connected to the chamber when the second assembly portion is mounted to the first assembly portion;
wherein the pump assembly is configured, in use, to extract air from the chamber to provide a predetermined vacuum pressure in the chamber.

2. A beverage degassing assembly according to claim 1, wherein the predetermined vacuum pressure is in the range from 40 kPa to 60 kPa, preferably in the range from 45 kPa to 55 kPa.

3. A beverage degassing assembly according to claim 1, wherein the predetermined vacuum pressure is selectively adjustable.

4. A beverage degassing assembly according to claim 1, wherein the pump assembly maintains the predetermined vacuum pressure for a predetermined time period.

5. A beverage degassing assembly according to claim 4, wherein the time period is in the range from 1 minute to 5 minutes, preferably from 1.5 minutes to 3 minutes.

6. A beverage degassing assembly according to claim 4, wherein the time period is selectively adjustable.

7. A beverage degassing assembly according to claim 1, wherein the pump assembly is mounted within the second assembly portion.

8. A beverage degassing assembly according to claim 1, the assembly further comprising a vacuum release port fluidly coupled to an ambient atmosphere, and wherein the vacuum release port is configured to be actuatable so as to selectively vent air into the chamber from the ambient atmosphere.

9. A beverage degassing assembly according to claim 1, wherein the first assembly portion and the second assembly portion comprise mutually disposed inter-engagement means.

10. A beverage degassing assembly according to claim 1, the beverage degassing assembly further comprising a detector configured to determine a tilt angle of a central longitudinal axis of the first assembly portion relative to a vertical axis.

11. A beverage degassing assembly according to claim 10, wherein the detector is configured to actuate an alarm signal when the tilt angle is greater than 30° relative to the vertical axis and, preferably, to actuate an alarm signal when the tilt angle is greater than 45° relative to the vertical axis.

12. A beverage degassing assembly according to claim 1, wherein the chamber is configured to receive a receptacle which is a receptacle of an infant feeding bottle assembly, an infant drinking cup assembly, or a breast pump assembly.

13. A beverage degassing assembly comprising:
a first assembly portion comprising a chamber and an opening to the chamber, wherein the chamber is configured to receive a receptacle for holding a beverage;
a second assembly portion comprising a pump assembly, wherein the second assembly portion is configured to be mountable to the first assembly in a first position; and
wherein, in the first position, the opening is selectively closed by the second assembly portion and the pump assembly is fluidly connected to the chamber to operably extract air from the chamber.

14. A beverage degassing assembly according to claim 13, wherein the pump assembly is configured to extract air from the chamber to provide a predetermined vacuum pressure in the chamber.

15. A method of degassing a beverage, the method comprising:
loading a receptacle containing a beverage into a chamber of a first assembly portion, wherein the receptacle is loaded through an opening of the chamber;
mounting a second assembly portion to the first assembly to close the opening;
fluidly connecting a pump assembly to the chamber; and
using the pump assembly to extract air from the chamber to provide a predetermined vacuum pressure in the chamber.

16. A method according to claim 15, wherein the pump assembly provides the predetermined vacuum pressure for a predetermined time period.

17. A method according to claim 15, further comprising a step of selectively venting air into the chamber, wherein the air is vented into the chamber using an actuatable vacuum release port fluidly coupled to an ambient atmosphere.
